(19) United States
(12) Patent Application Publication
(10) Pub. No.: US 2026/0078689 A1
(43) Pub. Date: Mar. 19, 2026

(54) COMPONENT PROTECTION CASING

(71) Applicant: RTX Corporation, Farmington, CT (US)

(72) Inventors: Lawrence Binek, East Hartford, CT (US); Justin Wotus, Vernon, CT (US)

(21) Appl. No.: 18/886,701

(22) Filed: Sep. 16, 2024

(51) Int. Cl. F01D 25/28; B22F 10/28; B29C 64/153; B29L 31/00; B33Y 10/00; B33Y 80/00

(52) U.S. Cl. CPC F01D 25/285; B22F 10/28; B29C 64/153; B33Y 10/00; B33Y 80/00; B22F 2998/10; B29L 2031/768

(57) ABSTRACT

A component protection casing includes a first segment that includes a first bias means configured to impart a bias load to a first surface of a gas turbine engine component, a second segment that includes a second bias means to impart a bias load to a second surface of the gas turbine engine component, and a latch mechanism configured to fasten the first segment to the second segment when the first segment and second segment are positioned in a closed configuration and the latch mechanism is engaged. The first segment and second segment are configured to receive and fully surround damage susceptible portions of a gas turbine engine component. The first bias load and second bias load are selected to secure the gas turbine engine component inside the component protection case when the first segment and second segment are positioned in a closed configuration and the latch mechanism is engaged.

### BACKGROUND

The present disclosure relates generally to a casing to protect gas turbine engine components and, more particularly, to a casing to protect gas turbine engine components made with a powder bed fusion additive machine.

As well known, gas turbine engines include a compressor section, combustor section, and turbine section. The compressor section and turbine section are often configured as rotors connected by a shaft. In some examples, the compressor section may have a single compressor connected by a shaft to a single turbine in the turbine shaft. In other examples, the compressor section may be divided into two or more compressors (e.g., a low pressure compressor and a high pressure compressor) connected by two or more shafts to two or more turbines (e.g., high pressure turbine and a low pressure turbine).

Certain very small gas turbine engines, which typically have a single compressor stage connected by a shaft to a single turbine stage, can be made with additive manufacturing (AM) techniques, including but not limited to laser powder bed fusion (PBF-LB) and other AM techniques.

Gas turbine engine rotors made with AM techniques can require multiple stages of mechanical post processing. In transportation between fixturing, it is possible for the rotor to be damaged. Certain very small gas turbine engines rotors can have very thin vanes that are highly susceptible to deformation or breakage if the rotor is improperly handled. There is no way using currently available techniques to repair such damage to the rotor.

### SUMMARY

One aspect of this disclosure is directed to a component protection casing including a first segment that includes a first bias means configured to impart a bias load to a first surface of a gas turbine engine component, a second segment that includes a second bias means to impart a bias load to a second surface of the gas turbine engine component, and a latch mechanism configured to fasten the first segment to the second segment when the first segment and second segment are positioned in a closed configuration and the latch mechanism is engaged. The first segment and second segment are configured to receive and fully surround damage susceptible portions of a gas turbine engine component. The first bias load and second bias load are selected to secure the gas turbine engine component inside the component protection case when the first segment and second segment are positioned in a closed configuration and the latch mechanism is engaged.

Another aspect of the disclosure is directed to a method of making a protective casing for a gas turbine engine that includes integrally forming during a first single, continuous additive manufacturing (AM) process a first segment including a first bias means and integrally forming during a second single, continuous AM process a second segment including a second bias means. A latch mechanism is configured to fasten the first segment to the second segment when the first segment and the second segment are positioned in a closed configuration and the latch mechanism is engaged. The first segment and second segment are configured to receive and fully surround damage susceptible portions of a gas turbine engine component. The first bias means and second bias means are configured to provide a bias load to at least two surfaces of the gas turbine engine component to secure the gas turbine engine inside the component protection case when the first segment and second segment are positioned in a closed configuration and the latch mechanism is engaged.

### BRIEF DESCRIPTION OF THE DRAWINGS

FIG. 1 is a view of a component protective casing of the present disclosure.

FIG. 2 is a cut-away view of a component protective casing of the present disclosure.

FIG. 3 is a view of an exemplary spring plug of the present disclosure.

FIG. 4A is a schematic plan view of an exemplary tessellated spring bed of the present disclosure.

FIG. 4B is a schematic plan view of another exemplary tessellated spring bed of the present disclosure.

### DETAILED DESCRIPTION

Gas turbine engine rotors can be made using traditional manufacturing methods (e.g., forging, casting, and other traditional methods) or by additive manufacturing methods, including powder bed fusion (PBF) additive manufacturing (AM) methods. PBF AM is an additive manufacturing, or 3-D printing, technology that uses an energy source, such as a laser (PBF-LB) or electron beam (PBF-EB), to sinter or fuse metallic or polymeric particles together in a layer-by-layer process. PBF is typically used as an industrial process to make near net shape parts with various geometries.

As discussed, gas turbine engine rotors made with AM techniques can require multiple stages of mechanical post processing. In transportation between fixturing, it is possible for the rotor to be damaged. Certain very small gas turbine engines rotors can have very thin vanes that are highly susceptible to deformation or breakage if the rotor is improperly handled. There is no way using currently available techniques to repair such damage to the rotor.

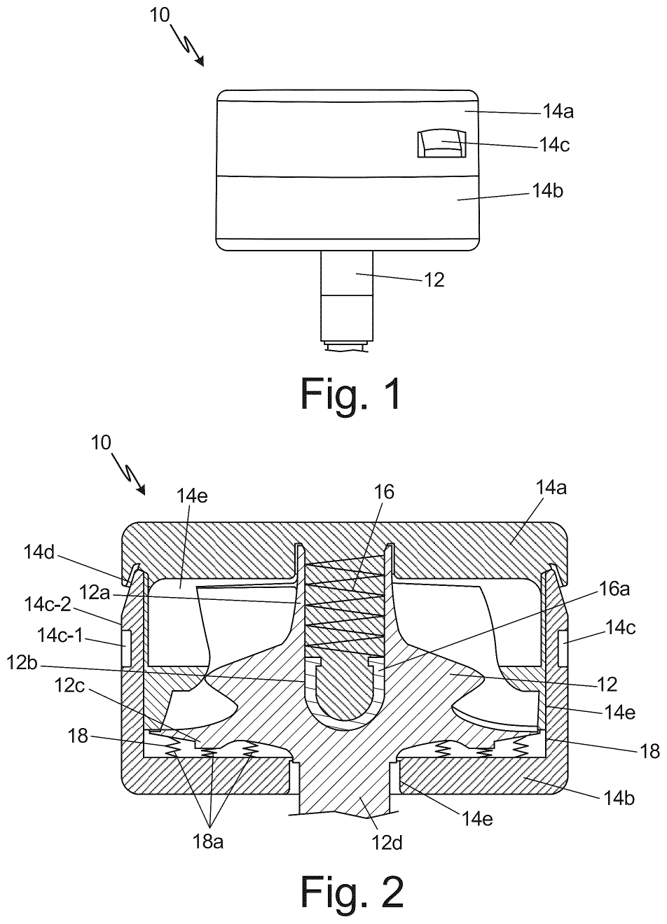

FIG. 1 shows a non-limiting, exemplary component protection casing 10 that is configured to protect a gas turbine engine component, such as a small gas turbine engine rotor 12 in transportation. While the component protection casing 10 of this disclosure can be used with any suitable gas turbine engine component, the component protection casing 10 will be discussed in the context of a gas turbine engine rotor 12. A person of ordinary skill will understand how to adapt the component protection casing 10 of this disclosure to be appropriate for other gas turbine engine components.

The component protection casing 10 of FIG. 1 includes two adjoining segments 14a and 14c with various bias features (see FIG. 2) that are configured to secure (i.e., protect) the gas turbine engine rotor 12 in the component protection casing 10 to protect the gas turbine engine rotor 12 from damage during transport. The first segment 14a and the second segment 14b are configured to receive and fully surround damage susceptible portions, which are discussed further below, of the gas turbine engine rotor 12 when the first segment 14a and the second segment 14b are in a closed (i.e., assembled) configuration as depicted in FIGS. 1 and 2. In some examples, at least one of the first segment 14a and the second segment 14b can include an orifice 14e that is configured to permit a damage tolerant portion of the gas turbine engine rotor 12 to pass through and not be surrounded by the first segment 14a and the second segment 14b when the first segment 14a and the second segment 14b are in a closed (i.e., assembled) configuration as depicted in FIGS. 1 and 2. The orifice 14e can be of any size and shape suitable to permit a damage tolerant portion of the gas turbine engine rotor 12 to pass through.

The component protection casing 10 also includes a latch 14c that is configured to fasten the two adjoining segments 14a and 14b. The latch 14c may be any latch capable of fastening the two adjoining segments 14a and 14b when damage susceptible portions of the gas turbine engine rotor 12 are fully surrounded by the two adjoining segments 14a and 14b and may include a first latch portion 14c-1 formed as part of the first segment 14a and a second latch portion 14c-2 formed as part of the second latch segment 14b. For example, the latch 14c can be a snap-fit latch as shown in FIG. 1 or any other latch deemed suitable for a particular application. Various types of snap-fit latches, including but not limited to cantilever snap joints, torsion snap joints, annular snap joints, snap-fit tab joints (illustrated in FIG. 1), snap-fit bead joints, snap-fit snap-latch joints, L-shaped snap joints, U-shaped snap joints, etc. are known and may be deemed suitable for a particular application. As discussed further below, the latch 14c can be formed using AM techniques as unitary, monolithic components of the two adjoining segments 14a and 14b or by any other manufacturing technique deemed suitable for a particular application.

FIG. 2 shows the first segment 14a fastened to the adjoining second segment 14b with latch 14c. As shown in FIG. 2, the component protective casing 10 may include more than one latch 14c. In the example of FIG. 2, the second segment 14b further engages with the first segment 14a at seal 14d. Seal 14d is shown as an interference fit seal, which may or may not include an elastomeric sealing component (e.g., and o-ring or similar device) and/or a snap-fit feature. In other examples, the second segment 14b may engage with the first segment 14a without a seal and instead may rely only on the latch 14c to fasten the first segment 14a to the adjoining second segment 14b.

FIG. 2 further shows that a first segment 14a of the component protection casing 10 includes a first bias means 16 that is configured to impart a bias load to a first surface 12b of the gas turbine engine rotor 12. The second segment 14b of the component protection casing 10 similarly includes a second bias means 18 that is configured to impart a bias load to a second surface 12c of a the gas turbine engine rotor 12. In the example depicted in FIG. 2, the first bias means can be a centered spring plug 16 that aligns with a balancing cavity 12a in the center of the gas turbine engine rotor 12 and the second bias means can be a spring bed 18. As the component protection casing 10 is closed to fully surround damage susceptible portions of the gas turbine engine rotor 12, the spring plug 16 and spring bed 18 compress to impart a bias load on non-flow path surfaces (e.g., hub surface 12b and back face 12c) of the gas turbine engine rotor 12. As shown, the spring bed 18 can include a plurality of smaller spring elements 18a that provide effective support for the gas turbine engine rotor 12 regardless of the gas turbine engine rotor's 12 stage of post-processing. For purposes of this disclosure, “damage susceptible portions of the gas turbine engine rotor 12” include portions of the gas turbine engine rotor (e.g., plurality of rotor vanes 12c) that can be damaged (particularly irreparably damaged) by impact of any kind, including dropping, bumping against a non-protected surface (including interior surfaces 14e of the component protections casing 10. For purposes of this disclosure, “damage tolerant portions of the gas turbine engine rotor 12” include portions of the gas turbine engine rotor (e.g., rotor shaft 12d) that are unlikely to be damaged (particularly irreparably damaged) by impact of any kind, including dropping, bumping against a non-protected surface (including interior surfaces 14e of the component protections casing 10.

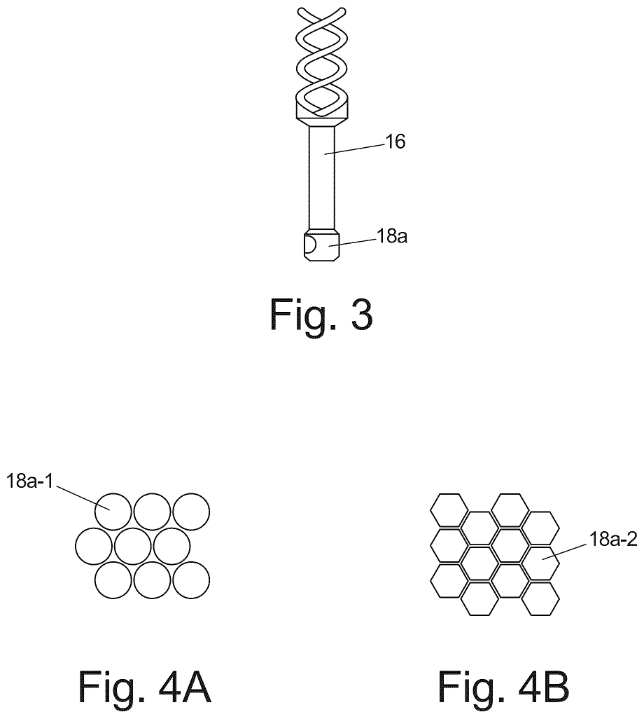

FIG. 3 shows an exemplary spring plug 16 that is configured to secure the gas turbine engine rotor 12 by imparting a bias load to the gas turbine engine rotor's 12 hub surface 12b. The spring plug 16 can be formed as a unitary, monolithic component of the first segment 14a formed during a first segment 14a AM build process. The spring plug 16 can include a spring head 16a that has a geometry and size configured to seat against the hub surface 12b (i.e., the balance stock) to impart a preselected bias load. The preselected bias load can be appropriate to secure the gas turbine engine rotor 12, in conjunction with the spring bed 18, in the component protection casing 10 to protect the gas turbine engine rotor 12 from damage during transport.

FIGS. 4A and 4B show two options for arranging the individual spring elements 18a of the spring bed 18 to impart a preselected bias load to the back face 12c of the gas turbine engine rotor 12. As shown in FIG. 2, the back face 12c can form part of the plurality of vanes of the gas turbine engine rotor 12 or any other appropriate surface of the gas turbine engine rotor 12. In some examples, the individual spring elements 18a can be positioned to interface only with portions of the back face 12c that will be machined as part of the post-processing performed on the gas turbine engine rotor 12 after the gas turbine engine rotor 12 is built with AM techniques. Such a configuration can avoid any damage to the gas turbine engine rotor 12 as it is secured inside the component protection casing 10. The spring bed 18, including individual spring elements 18a, can be formed as a unitary, monolithic component of the second segment 14b formed during a second segment 14b AM build process. FIGS. 4A and 4B show two examples of the spring bed 18 including individual spring elements 18a in a tessellated arrangement. In FIG. 4A, the individual spring elements 18a-1 are arranged in an adjoining circular pattern. In FIG. 4B, the individual spring elements 18a-2 are arranged in an adjoining hexagonal pattern. Using the patterns illustrated in FIGS. 4A and 4B (or other possible patterns not illustrated), the spring bed 18 can be configured to conform to the back face 12C of the gas turbine engine rotor 12 regardless of its stage of post processing.

The gas turbine engine rotor 12 and all elements of the component protection casing 10 can be built (“printed”) using a PBF AM process on a suitable PBF AM machine. The gas turbine engine rotor 12 can be built using any suitable material, including titanium, titanium alloys, copper alloy, nickel alloys, and other appropriate materials. The component protection casing 10 can be built using any material suitable to provide protection to the gas turbine engine rotor 12, including polymeric materials or metallic alloys that are compatible with the material used to build the gas turbine engine rotor 12. In the context of this disclosure a compatible material for the component protection casing 10 is any material that will not interact chemically, mechanically, or electrically with the material used to build the gas turbine engine rotor 12.

The component protection casing 10 of this disclosure can protect a high value component, such as the gas turbine engine rotor 12 from damage during post build transportation. The component protection casing 10 can be reused many times and can be used before and after mechanical post-processing of the part.

### Discussion of Possible Embodiments

The following are non-exclusive descriptions of possible embodiments of the present invention.

A component protection casing including a first segment that includes a first bias means configured to impart a bias load to a first surface of a gas turbine engine component, a second segment that includes a second bias means to impart a bias load to a second surface of the gas turbine engine component, and a latch configured to fasten the first segment to the second segment when the first segment and second segment are positioned in a closed configuration and the latch mechanism is engaged. The first segment and second segment are configured to receive and fully surround damage susceptible portions of a gas turbine engine component. The first bias load and second bias load are selected to secure the gas turbine engine component inside the component protection case when the first segment and second segment are positioned in a closed configuration and the latch mechanism is engaged.

The component protection casing of the preceding paragraph can optionally include, additionally and/or alternatively, any one or more of the following features, configurations and/or additional elements:

The second segment is configured to engage with the first segment at a seal.

The first segment is formed using additive manufacturing (AM) techniques and the first bias means is a unitary, monolithic component of the first segment formed during a first segment AM build process and the second segment is formed using AM techniques and the second bias means is a unitary, monolithic component of the first segment formed during a second segment AM build process.

At least one of the first segment and second segment includes an orifice configured to permit a damage tolerant portion of the gas turbine engine component to pass through and not be surrounded by the first segment and second segment when the first segment and second segment are in a closed configuration.

The gas turbine engine component is a gas turbine engine rotor and the damage susceptible portions of a gas turbine engine component are a plurality of vanes.

The damage tolerant portion of the gas turbine engine component further is a shaft portion that extends from the gas turbine engine rotor such that the shaft portion extends through the orifice when the first segment and second segment are in a closed configuration.

The gas turbine engine includes a hub with a hub surface and the first bias means is a spring plug that includes a spring head configured to engage with the hub surface to impart a preselected first bias load to the hub surface.

The second bias means is a spring bed configured to engage with removable surfaces of the gas turbine engine rotor vanes to impart a preselected second bias load to the gas turbine engine rotor vanes such that the combination of the preselected first bias load and the preselected second bias load are sufficient to secure the gas turbine engine component in the component protection case when the first segment and second segment are positioned in a closed configuration and the latch mechanism is engaged and wherein the removable surfaces of the gas turbine engine rotor vanes are configured to be removed with selected post-processing steps after the gas turbine engine rotor is built using AM techniques.

The spring bed comprises a plurality of spring elements organized in an adjoining circular pattern or/and adjoining hexagonal pattern.

The AM process is a powder bed fusion additive manufacturing process.

A method of making a protective casing for a gas turbine engine includes integrally forming during a first single, continuous additive manufacturing (AM) process a first segment including a first bias means and integrally forming during a second single, continuous AM process a second segment including a second bias means. A latch mechanism is configured to fasten the first segment to the second segment when the first segment and the second segment are positioned in a closed configuration and the latch mechanism is engaged. The first segment and second segment are configured to receive and fully surround damage susceptible portions of a gas turbine engine component. The first bias means and second bias means are configured to provide a bias load to at least two surfaces of the gas turbine engine component to secure the gas turbine engine inside the component protection case when the first segment and second segment are positioned in a closed configuration and the latch mechanism is engaged.

The method of the preceding paragraph can optionally include, additionally and/or alternatively, any one or more of the following features, configurations and/or additional elements:

Integrally forming during the first single, continuous AM process of a first segment a first latch portion and integrally forming during the second single, continuous AM process of a second segment a second latch portion.

The AM process is a powder bed fusion additive manufacturing process.

At least one of the first segment and second segment includes an orifice configured to permit a damage tolerant portion of the gas turbine engine component to pass through and not be surrounded by the first segment and second segment when the first segment and second segment are in a closed configuration.

The gas turbine engine component is a gas turbine engine rotor and the damage susceptible portions of a gas turbine engine component are a plurality of vanes.

The damage tolerant portion of the gas turbine engine component further is a shaft portion that extends from the gas turbine engine rotor such that the shaft portion extends through the orifice when the first segment and second segment are in a closed configuration.

The gas turbine engine includes a hub with a hub surface and the first bias means is a spring plug that includes a spring head configured to engage with the hub surface to impart a preselected first bias load to the hub surface.

The second bias means is a spring bed configured to engage with removable surfaces of the gas turbine engine rotor vanes to impart a preselected second bias load to the gas turbine engine rotor vanes such that the combination of the preselected first bias load and the preselected second bias load are sufficient to secure the gas turbine engine component in the component protection case when the first segment and second segment are positioned in a closed configuration and the latch mechanism is engaged and wherein the removable surfaces of the gas turbine engine rotor vanes are configured to be removed with selected post-processing steps after the gas turbine engine rotor is built using AM techniques.

The spring bed comprises a plurality of spring elements organized in an adjoining circular pattern or/and adjoining hexagonal pattern.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A component protection casing comprising:
a first segment that includes a first bias means configured to impart a bias load to a first surface of a gas turbine engine component;
a second segment that includes a second bias means to impart a bias load to a second surface of the gas turbine engine component; and
a latch mechanism configured to fasten the first segment to the second segment when the first segment and second segment are positioned in a closed configuration and the latch mechanism is engaged;
wherein the first segment and second segment are configured to receive and fully surround damage susceptible portions of a gas turbine engine component and the first bias load and second bias load are selected to secure the gas turbine engine component inside the component protection case when the first segment and second segment are positioned in a closed configuration and the latch mechanism is engaged.

2. The component protection casing of claim 1, wherein the second segment is configured to engage with the first segment at a seal.

3. The component protection casing of claim 1, wherein the first segment is formed using additive manufacturing (AM) techniques and the first bias means is a unitary, monolithic component of the first segment formed during a first segment AM build process and the second segment is formed using AM techniques and the second bias means is a unitary, monolithic component of the first segment formed during a second segment AM build process.

4. The component protection case of casing 1, wherein at least one of the first segment and second segment includes an orifice configured to permit a damage tolerant portion of the gas turbine engine component to pass through and not be surrounded by the first segment and second segment when the first segment and second segment are in a closed configuration.

5. The component protection casing of claim 4, wherein the gas turbine engine component is a gas turbine engine rotor and the damage susceptible portions of a gas turbine engine component are a plurality of vanes.

6. The component protection casing of claim 5, wherein the damage tolerant portion of the gas turbine engine component further is a shaft portion that extends from the gas turbine engine rotor such that the shaft portion extends through the orifice when the first segment and second segment are in a closed configuration.

7. The component protection casing of claim 6, wherein the gas turbine engine includes a hub with a hub surface and the first bias means is a spring plug that includes a spring head configured to engage with the hub surface to impart a preselected first bias load to the hub surface.

8. The component protection casing of claim 7, wherein the second bias means is a spring bed configured to engage with removable surfaces of the gas turbine engine rotor vanes to impart a preselected second bias load to the gas turbine engine rotor vanes such that the combination of the preselected first bias load and the preselected second bias load are sufficient to secure the gas turbine engine component in the component protection case when the first segment and second segment are positioned in a closed configuration and the latch mechanism is engaged and wherein the removable surfaces of the gas turbine engine rotor vanes are configured to be removed with selected post-processing steps after the gas turbine engine rotor is built using AM techniques.

9. The component protection casing of claim 8, wherein the spring bed comprises a plurality of spring elements organized in an adjoining circular pattern or/and adjoining hexagonal pattern.

10. The component protection casing of claim 3, wherein the AM process is a powder bed fusion additive manufacturing process.

11. A method of making a protection casing for a gas turbine engine component comprising:
integrally forming during a first single, continuous additive manufacturing (AM) process a first segment including a first bias means;
integrally forming during a second single, continuous AM process a second segment including a second bias means; and
a latch mechanism configured to fasten the first segment to the second segment when the first segment and second segment are positioned in a closed configuration and the latch mechanism is engaged
wherein the first segment and second segment are configured to receive and fully surround damage susceptible portions of a gas turbine engine component and the first bias means and second bias means are configured to provide a bias load to at least two surfaces of the gas turbine engine component to secure the gas turbine engine inside the component protection case when the first segment and second segment are positioned in a closed configuration and the latch mechanism is engaged.

12. The method of claim 11, further comprising:
integrally forming during the first single, continuous AM process of a first segment a first latch portion; and
integrally forming during the second single, continuous AM process of a second segment a second latch portion.

13. The method of claim 11, wherein the AM process is a powder bed fusion additive manufacturing process.

14. The method of casing 11, wherein at least one of the first segment and second segment includes an orifice configured to permit a damage tolerant portion of the gas turbine engine component to pass through and not be surrounded by the first segment and second segment when the first segment and second segment are in a closed configuration.

15. The method of claim 14, wherein the gas turbine engine component is a gas turbine engine rotor and the damage susceptible portions of a gas turbine engine component are a plurality of vanes.

16. The method of claim 15, wherein the damage tolerant portion of the gas turbine engine component further is a shaft portion that extends from the gas turbine engine rotor such that the shaft portion extends through the orifice when the first segment and second segment are in a closed configuration.

17. The method of claim 16, wherein the gas turbine engine includes a hub with a hub surface and the first bias means is a spring plug that includes a spring head configured to engage with the hub surface to impart a preselected first bias load to the hub surface.

18. The method of claim 17, wherein the second bias means is a spring bed configured to engage with removable surfaces of the gas turbine engine rotor vanes to impart a preselected second bias load to the gas turbine engine rotor vanes such that the combination of the preselected first bias load and the preselected second bias load are sufficient to secure the gas turbine engine component in the component protection case when the first segment and second segment are positioned in a closed configuration and the latch mechanism is engaged and wherein the removable surfaces of the gas turbine engine rotor vanes are configured to be removed with selected post-processing steps after the gas turbine engine rotor is built using AM techniques.

19. The method of claim 18, wherein the spring bed comprises a plurality of spring elements organized in an adjoining circular pattern or/and adjoining hexagonal pattern.
